(19) United States
(12) Patent Application Publication
(10) Pub. No.: US 2025/0353161 A1
(43) Pub. Date: Nov. 20, 2025

(54) FASTENER DRIVER TOOL

(71) Applicant: Robert Bosch GmbH, Stuttgart (DE)

(72) Inventors: Eric Siegel, Arlington Heights, IL (US); Balazs Nagy, Roselle, IL (US); Walter Bernardi, Highland Park, IL (US); Jeremy Rubens, Palatine, IL (US); Greg Herman, Elk Grove Village, IL (US); Jaimie Moreno Terrazas, Imperial, CA (US); Michael Gabel, Park Ridge, IL (US)

(21) Appl. No.: 19/211,721

(22) Filed: May 19, 2025

Related U.S. Application Data
(60) Provisional application No. 63/649,780, filed on May 20, 2024.

(51) Int. Cl. B25F 5/02; B25C 1/06; B25C 5/15; B25C 7/00

(52) U.S. Cl. CPC B25F 5/02; B25C 1/06; B25C 5/15; B25C 7/00

(57) ABSTRACT

A fastener driver tool includes a housing, a drive mechanism, a battery pack, and a fastener magazine. The housing has a grip portion located between a power supply portion and a drive portion. The drive mechanism includes (i) a motor, (ii) a gearbox operably connected to the motor, and (iii) a striking mechanism operably connected to the gearbox. The battery pack is received by the power supply portion and is configured to supply the motor with electrical energy. The fastener magazine is configured to hold a plurality of fasteners. The fastener magazine is mounted on the housing and operably connected to the striking mechanism. The motor and the gearbox are located in the grip portion of the housing. The striking mechanism is located in the drive portion of the housing. A center of gravity of the fastener driver tool is located within the grip portion.

This application claims the benefit of priority of U.S. provisional application Ser. No. 63/649,780, filed on May 20, 2024 the disclosure of which is herein incorporated by reference in its entirety.

### FIELD

This disclosure relates to the field of power tools and particularly to devices and tools used to drive fasteners into workpieces.

### BACKGROUND

Fasteners such as nails and staples are commonly used in projects ranging from crafts to building construction. While manually driving such fasteners into a workpiece is effective, a user may quickly become fatigued when involved in projects requiring a large number of fasteners and/or physically large fasteners to be driven into a workpiece. Moreover, proper driving of larger fasteners into a workpiece frequently requires more than a single impact from a manual tool.

In response to the shortcomings of manual driving tools, power-assisted devices for driving fasteners into workpieces have been developed. Contractors and homeowners commonly use such devices for driving fasteners ranging from brad nails used in small projects, to common nails which are used in framing and other construction projects, to staples which are used in large and small projects. Compressed air has been traditionally used to provide power for the power-assisted (pneumatic) devices. Specifically, a source of compressed air is used to actuate a cylinder which impacts a nail into the workpiece. Such systems, however, require an air compressor, increasing the cost of the system and limiting the portability of the system. In response, fuel cells were developed for use as a source of power for power-assisted devices. The fuel cell is generally provided in the form of a cylinder which is removably attached to the device. Systems with fuel cells rely on the rapid expansion of a gas to the cylinder and thus impact a fastener into a workpiece. These systems are relatively complicated as both electrical systems and fuel systems are required to produce the expansion of gases.

Another source of power that has been used in power assisted devices is electrical power. Traditionally, electrical devices have been mostly limited to use in impacting smaller fasteners such as staples, tacks, and brad nails. In these devices, a solenoid driven by electrical power from an external source is used to impact the fastener. The force that can be achieved using a solenoid, however, is limited by the physical structure of the solenoid. Various approaches have been used to address the limitations of electrical devices. In some systems, multiple impacts are used. This approach requires the tool to be maintained in position for a relatively long time to drive a fastener. Another approach is the use of a spring to store energy. In this approach, the spring is cocked (or activated) through an electric motor. Once sufficient energy is stored within the spring, the energy is released from the spring into an anvil which then impacts the fastener into the substrate.

Other fastener drivers use a flywheel to store energy for use in impacting a fastener. The flywheel is used to launch a hammering anvil that impacts the nail or other fastener. A DC motor rotates the flywheel and once a predetermined flywheel speed is reached the flywheel is moved into engagement with a driving mechanism that impacts a fastener at the end of a fastener magazine. Details of a fastener driver using a flywheel mechanism are disclosed in U.S. Pat. Nos. 7,934,565 and 8,746,526, the disclosures of which are incorporated herein.

The fasteners, such as nails or staples, are held in a magazine or cartridge that is mounted to body of the fastener driver. The magazine provides a uniform guide track that allows the fasteners to enter the drive mechanism with a proper and consistent alignment. A consideration with nailer assemblies is the weight of the assembly. The housing and drive mechanism of the fastener driver can weigh 7-10 lbs. A magazine holding a sufficient number of fasteners to preclude excessive time refilling the driver or nailer assembly can result in a substantial weight of fasteners, on the order of 1-2 lbs. when the fasteners are relatively large and heavy. The overall weight can be tiresome for a handheld tool, especially when the tool is used to drive fasteners horizontally into a workpiece, such as when mounting a trim piece to a vertical wall. Moreover, and equally significantly, the orientation of the weight of the conventional fastener driver makes the tool cumbersome to align properly relative to the workpiece.

In the example tool T shown in FIG. 1A, a center of gravity CG of the tool T is significantly offset from the fastener magazine M and the impact point I of the tool. Moreover, the hand grip G is significantly offset from the impact point I. The position of the hand grip G and the center of gravity CG relative to the impact point I produces a counter-clockwise moment as the user tries to maneuver the tool into proper alignment for driving the fastener into the workpiece. This moment is aggravated by the cantilevered loads due to the weight of the tool T as the user manipulates the tool at arm's length, as depicted in FIG. 1B. This moment imposes a load on the user's wrist as the user works to resist the moment while maneuvering the tool T.

### SUMMARY

According to an exemplary embodiment of the disclosure, a fastener driver tool includes a housing, a drive mechanism, a battery pack, and a fastener magazine. The housing has a grip portion located between a power supply portion and a drive portion. The drive mechanism includes (i) a motor, (ii) a gearbox operably connected to the motor, and (iii) a striking mechanism operably connected to the gearbox. The battery pack is received by the power supply portion and is operably connected to the motor. The fastener magazine is configured to hold a plurality of fasteners. The fastener magazine is mounted on the housing and operably connected to the striking mechanism. The motor and the gearbox are located in the grip portion of the housing. The striking mechanism is located in the drive portion of the housing. The striking mechanism is configured to strike a corresponding fastener of the plurality of fasteners using rotation from the gearbox as rotated by the motor supplied with electrical energy from the battery pack. A center of gravity of the fastener driver tool is located within the grip portion.

According to another exemplary embodiment of the disclosure, a fastener driver tool includes a housing a drive mechanism, a power supply, and a fastener magazine. The housing has a grip portion located between a power supply portion and a drive portion. The drive mechanism includes (i) a motor, (ii) a gearbox operably connected to the motor, and (iii) a striking mechanism operably connected to the gearbox. The power supply is received by the power supply portion and is configured to supply the motor with electrical energy. The fastener magazine is configured to hold a plurality of fasteners. The fastener magazine is mounted on the housing and operably connected to the striking mechanism. The motor and the gearbox are located in the grip portion of the housing. The striking mechanism is located in the drive portion of the housing. The striking mechanism is configured to strike a corresponding fastener of the plurality of fasteners using rotation from the gearbox as rotated by the motor. A center of gravity of the fastener driver tool is located within the gearbox.

### BRIEF DESCRIPTION OF THE FIGURES

The above-described features and advantages, as well as others, should become more readily apparent to those of ordinary skill in the art by reference to the following detailed description and the accompanying figures in which:

FIG. 1A shows a prior art fastener driver tool;

FIG. 1B shows the prior art tool of FIG. 1A in use;

FIG. 2 shows a side view of a fastener driver tool according to the present disclosure;

FIG. 3 is a cross-sectional view of the tool shown in FIG. 2 showing a drive mechanism within a housing of the tool;

FIG. 4 shows the tool of FIG. 2 including a shoulder strap;

FIG. 5 is a diagrammatic representation of the tool shown in FIG. 2 with exemplary dimensions of the tool; and

FIG. 6 shows a side view of another embodiment of the fastener driver tool.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

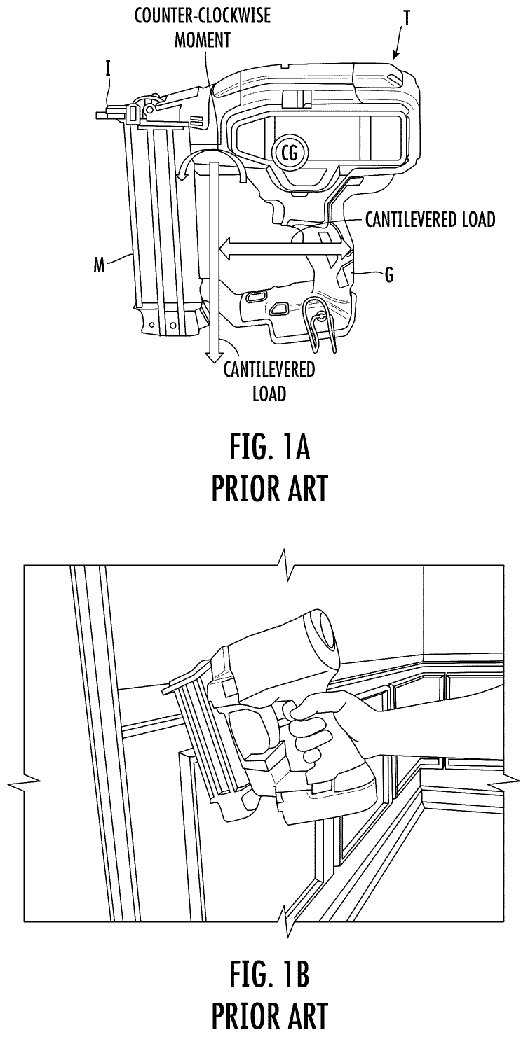

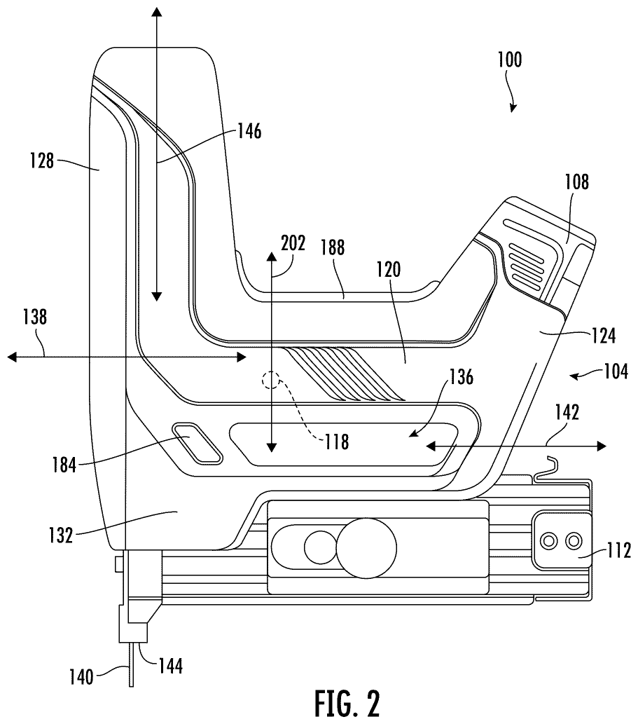

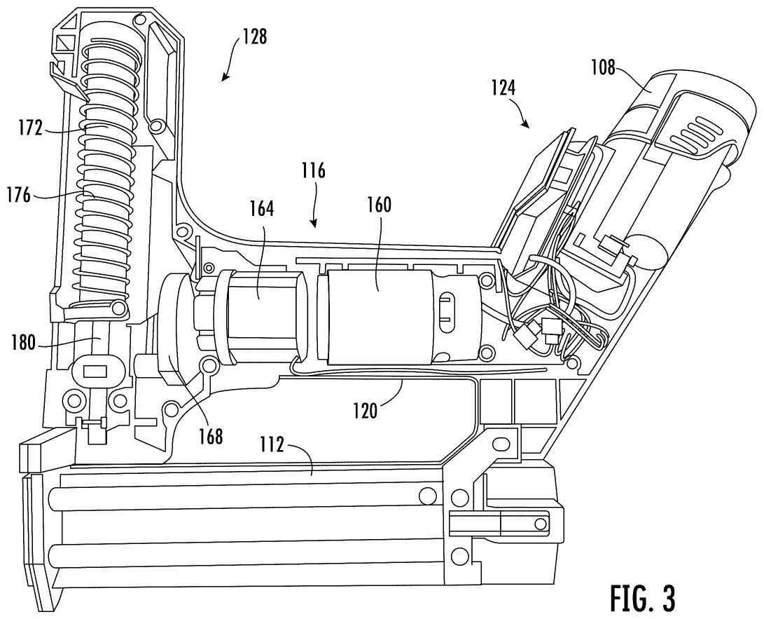

According to the present disclosure, a fastener driver tool 100 is provided that addresses the weight and balance problems of the prior art driver tools, such as the tool T shown in FIGS. 1A, 1B. As shown in FIG. 2, the tool 100 includes a housing 104, a battery pack 108, and a fastener magazine 112. A drive mechanism 116 (FIG. 3) of the tool 100 is located within the housing 104. As described herein, a center of gravity 118 of the tool 100 is optimally located to balance the tool 100 and to reduce the undesirable moments and cantilevered loads of the prior art tool T, thereby making the tool 100 of the present disclosure more comfortable to operate. Each element of the tool 100 is described below.

The housing 104, in one embodiment, is formed of a lightweight and durable material, such as a plastic or resin material. For example, the housing 104 is formed of two mating halves and includes interior features (see FIG. 3) to support and orient the working components of the tool 100. The housing 104 defines a hand grip portion 120, a power supply portion 124, a drive portion 128, and a cartridge support portion 132. It can be appreciated from FIG. 2 that the drive portion 128 and the power supply portion 124 are arranged to flank the grip portion 120, essentially forming an ergonomic saddle between the two portions 124, 128 for a comfortable and stable grip by the user.

In one embodiment, the grip portion 120 is barrel-shaped and ergonomically configured for a comfortable grip by the user. The hand grip portion 120 is offset from the cartridge support portion 132, such that the housing 104 defines a finger opening 136 sized to receive the fingers of the user when gripping the grip portion 120. The grip portion 120 is located between the power supply portion 124 and the drive portion 128. The finger opening 136 is located between the grip portion 120 and fastener magazine 112. The grip portion 120 defines a longitudinal grip axis 138, and the finger opening 136 defines a finger longitudinal axis 142 that is parallel to the longitudinal grip axis 138.

The fastener magazine 112 is mounted on the cartridge support portion 132 of the housing 104. The fastener magazine 112 is configured to hold a plurality of fasteners 140 one of which is shown in FIG. 2. The fastener magazine 112 contains any type of fastener, such as nails and staples, and is configured to be reloaded as needed. The fastener magazine 112 feeds the fasteners 140 to an impact point 144 of the tool 100 where the drive mechanism 116 impacts the fastener 140 to drive the fastener 140 into a workpiece.

The power supply portion 124 contains and/or supports a power supply of the tool 100. As shown in FIG. 2, the exemplary power supply is the removable and rechargeable battery pack 108. The battery pack 108 is received by the power supply portion 124 of the housing 104. The battery pack 108 provides electrical energy. In another embodiment, the power supply an AC power supply (not shown) is configured for connection to a mains power supply with a corresponding cable or cord (not shown).

The drive portion 128 of the housing 104 contains the drive mechanism 116. As shown in FIG. 2, the drive portion 128 defines a drive longitudinal axis 146. The longitudinal grip axis 138 is perpendicular to the drive longitudinal axis 146.

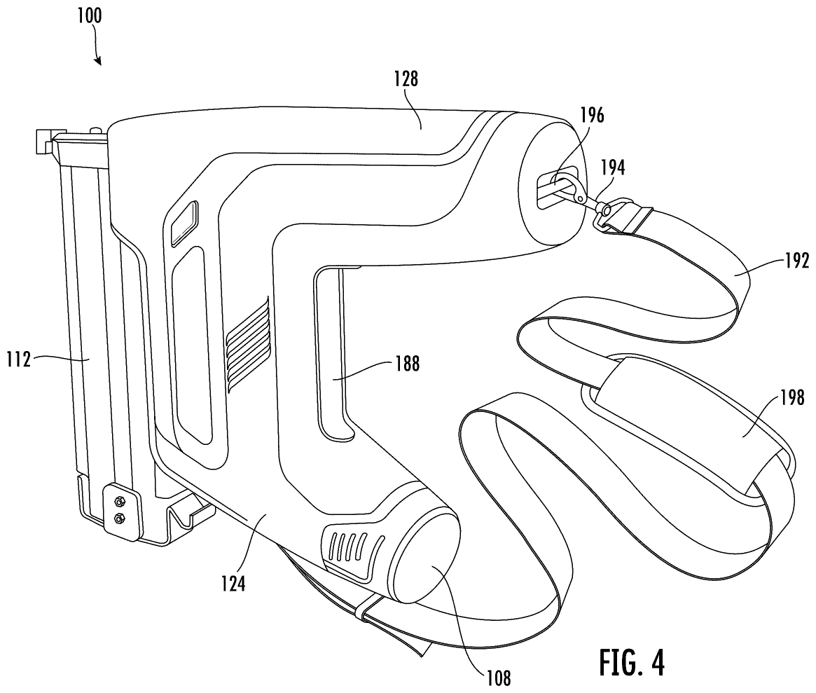

With reference to FIG. 4, the drive mechanism 116 of the tool 100 includes a motor 160, a gearbox 164, a crank mechanism 168, and a striking mechanism 172. The motor 160 is an electric motor that receives electrical energy from the power supply, such as the battery pack 108, such that the battery pack 108 is operably connected to the motor 160. In embodiments of the tool 100 without the battery pack 108, the motor 160 received power from the AC power supply. The motor 160 is provided as a brushless motor or a brushed motor.

The gearbox 164, in one embodiment, includes reduction gears such that an output of the gearbox 164 rotates more slowly than an output of the motor 160 and with a greater torque. The gearbox 164 is operably connected to the motor 160. In one embodiment, the gearbox 164 is a relatively heavy element of the drive mechanism 116 and includes a metal housing and metal gears. The longitudinal grip axis 138 extends through the gearbox 164.

The crank mechanism 168 is operably connected to the output of the gearbox 164 and to an input of the striking mechanism 172. The crank mechanism 168 is operable to compress a spring 176 of the striking mechanism 172 using rotation of the motor 160 and the gearbox 164, as powered by the power supply. Moreover, the crank mechanism 168 is configured to release the compressed spring 176 so that the spring 176 generates a striking force. In one embodiment, the crank mechanism 168 is located within the housing 104 at an interface of the grip portion 120 and the drive portion 128.

The striking mechanism 172 includes at least the spring 176 and an anvil 180. The striking mechanism 172 is located in the drive portion 128 of the housing 104. The striking mechanism 172 is operably connected to the gearbox 164 through the crank mechanism 168. In one embodiment, the spring 176 is a compression spring. In response to crank mechanism 168 releasing the compressed spring 176, the spring 176 exerts the striking force on the anvil 180. The anvil 180 then strikes a corresponding one of the fasteners 140, and drives the fastener 140 into the workpiece. The fastener magazine 112 is operably connected to the striking mechanism 172 to provide the fasteners 140 to the anvil 180. The anvil 180 forces the fastener 140 from the fastener magazine 112 at the impact point 144. Thus, the striking mechanism 172 is configured to strike the corresponding fastener 140 using rotation from the gearbox 164 as rotated by the motor 160, which is supplied with electrical energy from the battery pack 108 or other power supply.

As shown in FIG. 2, the tool 100 further includes an activation button 184 and a safety switch 188. The activation button 184 is mounted on the housing 104. When the user presses the activation button 184, assuming the safety switch 188 and all other safety interlocks are active, the drive mechanism 116 is activated for striking the corresponding fastener 140. As shown in FIG. 2, the finger longitudinal axis 142 passes through the activation button 184. The exemplary activation button 184 is mirrored on opposite sides of the housing 104 to permit left-hand and right-hand grip and activation. In one embodiment, one of the mirrored activation buttons 184 is depressed to activate the drive mechanism 116 of the tool 100. In another embodiment, both of the mirrored activation buttons 184 are pressed simultaneously to activate the drive mechanism 116, such as by pinching between the user's thumb and forefinger. Thus, the tool 100 uses two points of activation in order to activate the drive mechanism 116. It is noted that in this embodiment, the safety switch 188 is not included because the pinching action provides two points of actuation.

The safety switch 188, as shown in FIG. 2, is mounted on the grip portion 120. The safety switch 188 is activated in order to allow operation of the activation button 184. Thus, the tool 100, in one embodiment, provides the two points of activation (i.e., one activation button 184 and the safety switch 188) in order to activate the drive mechanism 116. In the illustrated embodiment, the safety switch 188 is a lever that is depressed when the user grips the tool 100. In another embodiment, the safety switch 188 is a passive hand sensor-such as a capacitive zone, inductive zone, or electronic pressure pad-that detects when the grip portion 120 is grasped by the user.

As shown in FIG. 4, the fastener driver tool 100 includes a shoulder strap 192 that can be removably fastened with conventional clips 194 (only one of which is visible in FIG. 4) to the housing 104 of the tool 100. More particularly, the clips 194 at the ends of the strap 192 engage corresponding a fitting 196 at the end of the drive portion 128 of the housing 104 and another fitting 196 (not visible in FIG. 4) near the end of the power supply portion 124. Thus, the strap 192 has a first end removably connected to the drive portion 128 of the housing 104 and a second end removably connected to the power supply portion 124 of the housing 104.

A pad 198 is slidably mounted on the strap 192. The strap 192 can also be provided with a storage container (not shown) for storing various attachments or components used with the tool 100.

The shoulder strap 192 allows the user to keep the tool 100 close at hand during a nailing/stapling process. In many instances, the workpiece must be continuously supported by the user during the process, such as when a molding strip is being fastened to a vertical wall. In instances like these, having the tool 100 close at hand is essentially so that the user does not need to release the workpiece simply to retrieve the tool 100. The strap 192 allows the user to carry the tool 100 so that it is always at the ready. In another feature, the strap 192 is arranged and sized to help the user hold the tool 100 when aligning and activating the tool 100. First, the strap 192 is arranged to engage the opposite ends of the fastener driver tool 100, rather than centered at a single location on the tool 100. Thus, the strap 192 and the tool 100 essentially form a continuous loop, with the user exerting an outward force from inside the loop as the user maneuvers the tool 100. Second, the strap 192 is sized so that the strap 192 can be wrapped around the user's upper body. The combination of these two features allows the user to maintain the strap 192 in tension while maneuvering the tool 100 into proper alignment with the workpiece. The strap 192 tension operates as a lever to support the tool 100 as the tool 100 is moved up and down or side-to-side into proper alignment. This feature not only assists in aligning the tool 100, it also reduces muscle fatigue in the user. First, the strap 192 bears some part of the weight of the tool 100. Furthermore, maintaining the strap 192 in tension during use allows the user to activate muscles other than the arm muscles to maneuver the tool 100 so that the workload for supporting and manipulating the tool 100 is shared with the larger muscles of the upper body.

In order to optimally position the center of gravity 118 of the tool 100, the tool 100 incorporates the majority of the drive mechanism 116 into the barrel-shaped grip portion 120 of the housing 104, as shown in FIG. 4, such that the center of gravity 118 is located within the grip portion 120 of the housing 104. More specifically, in one embodiment, the center of gravity 118 is located at a region of the grip portion 120 engaged by the user's thumb and forefinger. In an embodiment, the center of gravity 118 is located within the gearbox 164. The center of gravity 118 is a point at which an entire weight of the tool 100, including the battery pack 108 (when equipped), may be considered as concentrated. The center of gravity 118 is a point at which the tool 100, including the battery pack 108 (when equipped), is in balance in reference to gravity.

In one embodiment, the optimal center of gravity 118 location is achieved by locating the motor 160 and the gearbox 164 completely within the grip portion 120 of the housing 104. This arrangement places a majority of the weight of the drive mechanism 116 in the grip portion 120, and positions the center of gravity 118 as close to the user's gripping hand as possible in the grip portion 120. Additionally, a majority of the components of the drive mechanism 116 is disposed within the grip portion 120 so that the weight of those components is directly supported by the user's grip. Moreover, due to the configuration of the housing 104, the grip portion 120 itself is close as possible to the fastener magazine 112 and the impact point 144, which significantly reduces or eliminates the counter-clockwise moment generated during positioning and operation of the fastener driver tool 100 versus the prior art fastener driver T discussed above. Specifically, the center of gravity 118, is oriented at the lower third of the drive portion 128 and is positioned closer to the fastener magazine 112 and the impact point 144 than the prior art tool T. Viewed in another way, the grip portion 120 of the tool 100 moves the user's grip forward toward the drive portion 128 and downward toward the impact point 144. The housing 104 is thus configured so that the center of gravity 118 is preferably within the envelop of the user's grip on the grip portion 120, or at least in close proximity to the grip portion 120. The counter-clockwise moment generated by the prior art tool T (see FIG. 1B) is negligible for the tool 100 of the present disclosure. The user can handle the cantilever vertical and horizontal loads (see FIG. 1A) with the forearm and the user does not need to resist the moment at the user's wrist. This improves the ability of the user to accurately align the working end of the tool 100 relative to the workpiece, and reduces the muscular fatigue caused by repeatedly lifting and aligning the tool 100.

The specific location of the center of gravity 118 is described below in relation to several reference points. For example, in one embodiment, the center of gravity 118 is closer to the activation button 184 than the power supply portion 124 of the housing 104 along the longitudinal grip axis 138. Additionally, the center of gravity 118 is closer to the drive portion 128 of the housing 104 than the power supply portion 124. Positioning the center of gravity 118 in the illustrated location provides the benefits described above.

In one embodiment, a plane 202 normal to the longitudinal grip axis 138 passes through the center of gravity 118. Moreover, the plane 202 passes through a thumb and forefinger of an operator of the tool 100, as the operator grips the grip portion 120 for activating the activation button 184. Having the center of gravity 118 near the operator's thumb and forefinger, along the longitudinal grip axis 138, provides the benefits described above.

From another perspective, the center of gravity 118 is located between the safety switch 188 and the finger opening 136 along the drive longitudinal axis 146, to provide the above-described benefits to the tool 100.

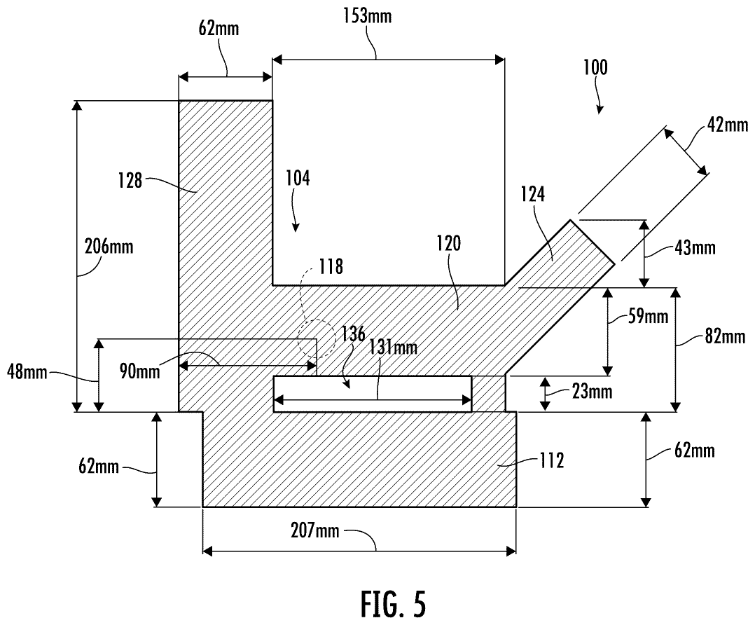

With reference to FIG. 5, the fastener driver tool 100 of the present disclosure is sized for manual use by any user, ranging from the DIYer to the professional. Exemplary dimensions are shown in FIG. 5, particularly pointing out the location of the center of gravity 118 relative to the drive portion 128, the impact point 144, and the grip portion 120. Other dimensions are possible in relation to the size and type of fasteners being dispensed at the impact point 144.

In another embodiment, drive mechanism 116 of the tool 100 includes the motor 160 and a flywheel apparatus (not shown), as described above in connection with the prior art tool T.

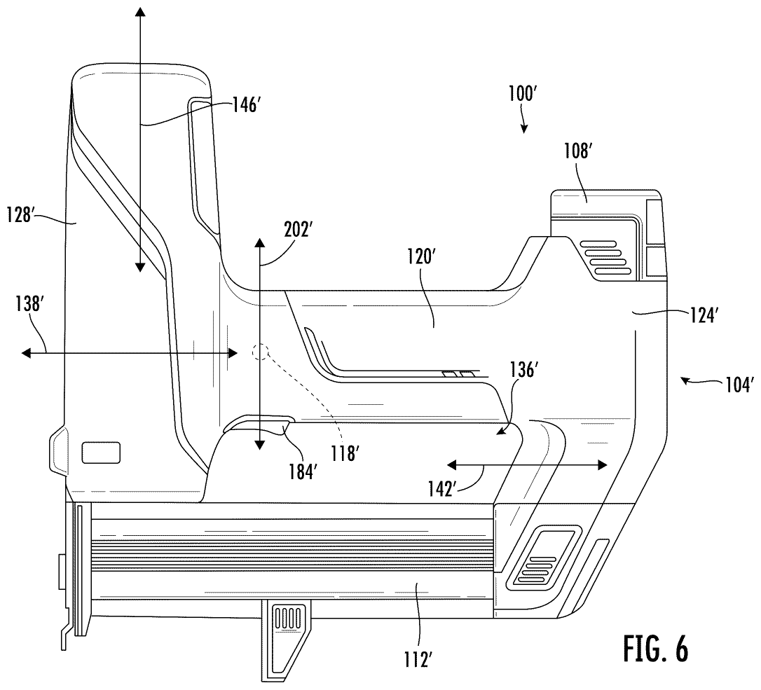

As shown in FIG. 6, another embodiment of the fastener driver tool 100′ includes a housing 104′, a battery pack 108′, a fastener magazine 112′, a grip portion 120′, a power supply portion 124′, a drive portion 128′, a finger opening 136′, a longitudinal grip axis 138′, a finger longitudinal axis 142′, a drive longitudinal axis 146′, and a plane 202′. The tool 100′ includes a drive mechanism (not shown) that is substantially the same as the drive mechanism 116 of the tool 100. The tool 100′ includes an activation button 184′ through which the plane 202′ extends. A center of gravity 118′ of the fastener driver tool 100′ is optimally located to balance the tool 100′ and to reduce the undesirable moments and cantilevered loads of the prior art tool T, thereby making the tool 100′ of the present disclosure more comfortable to operate.

In order to optimally position the center of gravity 118′ of the tool 100′, the tool 100′ incorporates the majority of the drive mechanism into the barrel-shaped grip portion 120′ of the housing 104′, such that the center of gravity 118′ is located within the grip portion 120′ of the housing 104′. More specifically, in one embodiment, the center of gravity 118′ is located at a region of the grip portion 120′ engaged by the user's thumb and forefinger. The center of gravity 118′ is aligned along the drive longitudinal axis 146′ with the activation button 184′. The plane 202′ extends through the center of gravity 118′ and the activation button 184′. In an embodiment, the center of gravity 118′ is located within a gearbox (not shown, substantially the same as the gearbox 164 of the tool 100) of the tool 100′.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A fastener driver tool, comprising:
a housing having a grip portion located between a power supply portion and a drive portion;
a drive mechanism including (i) a motor, (ii) a gearbox operably connected to the motor, and (iii) a striking mechanism operably connected to the gearbox;
a battery pack received by the power supply portion and configured to supply the motor with electrical energy; and
a fastener magazine configured to hold a plurality of fasteners, the fastener magazine mounted on the housing and operably connected to the striking mechanism,
wherein the motor and the gearbox are located in the grip portion of the housing,
wherein the striking mechanism is located in the drive portion of the housing,
wherein the striking mechanism is configured to strike a corresponding fastener of the plurality of fasteners using rotation from the gearbox as rotated by the motor, and
wherein a center of gravity of the fastener driver tool is located within the grip portion.

2. The fastener driver tool as claimed in claim 1, further comprising:
an activation button mounted on the housing and configured to activate the drive mechanism for striking the corresponding fastener,
wherein the grip portion defines a longitudinal grip axis,
wherein the center of gravity is closer to the activation button than the power supply portion along the longitudinal grip axis.

3. The fastener driver tool as claimed in claim 2, wherein:
a plane normal to the longitudinal grip axis passes through the center of gravity, and
the plane further passes through a thumb and forefinger of an operator, as the operator grips the grip portion for activating the activation button.

4. The fastener driver tool as claimed in claim 1, wherein the center of gravity is closer to the drive portion than the power supply portion.

5. The fastener driver tool as claimed in claim 1, wherein:
the housing further defines a finger opening located between the grip portion and the fastener magazine.

6. The fastener driver tool as claimed in claim 5, further comprising:
a safety switch mounted on the grip portion,
wherein the drive portion defines a drive longitudinal axis, and
wherein the center of gravity is located between the safety switch and the finger opening along the drive longitudinal axis.

7. The fastener driver tool as claimed in claim 5, further comprising:
an activation button mounted on the housing and configured to activate the drive mechanism for striking the corresponding fastener,
wherein the drive portion defines a drive longitudinal axis,
wherein the grip portion defines a grip longitudinal axis that is perpendicular to the drive longitudinal axis,
wherein the finger opening defines a finger longitudinal axis that is parallel to the grip longitudinal axis, and
wherein the finger longitudinal axis passes through the activation button.

8. The fastener driver tool as claimed in claim 1, further comprising:
a strap having a first end removably connected to the drive portion of the housing and a second end removably connected to the power supply portion of the housing.

9. The fastener driver tool as claimed in claim 1, further comprising:
a crank mechanism operably connected to the gearbox and the striking mechanism, the crank mechanism configured to compress a spring of the drive mechanism using rotation from the gearbox,
wherein the crank mechanism is located in the housing at an interface of the grip portion and the drive portion.

10. A fastener driver tool, comprising:
a housing having a grip portion located between a power supply portion and a drive portion;
a drive mechanism including (i) a motor, (ii) a gearbox operably connected to the motor, and (iii) a striking mechanism operably connected to the gearbox;
a power supply received by the power supply portion and configured to supply the motor with electrical energy; and
a fastener magazine configured to hold a plurality of fasteners, the fastener magazine mounted on the housing and operably connected to the striking mechanism,
wherein the motor and the gearbox are located in the grip portion of the housing,
wherein the striking mechanism is located in the drive portion of the housing,
wherein the striking mechanism is configured to strike a corresponding fastener of the plurality of fasteners using rotation from the gearbox as rotated by the motor, and
wherein a center of gravity of the fastener driver tool is located within the gearbox.

11. The fastener driver tool as claimed in claim 10, further comprising:
an activation button mounted on the housing and configured to activate the drive mechanism for striking the corresponding fastener,
wherein the grip portion defines a longitudinal grip axis that extends through a center of the gearbox,
wherein the center of gravity is closer to the activation button than the power supply portion along the longitudinal grip axis.

12. The fastener driver tool as claimed in claim 11, wherein:
a plane normal to the longitudinal grip axis passes through the center of gravity, and
the plane further passes through a thumb and forefinger of an operator, as the operator grips the grip portion for activating the activation button.

13. The fastener driver tool as claimed in claim 10, wherein the center of gravity is closer to the drive portion than the power supply portion.

14. The fastener driver tool as claimed in claim 10, wherein:
the housing further defines a finger opening located between the grip portion and the fastener magazine.

15. The fastener driver tool as claimed in claim 14, further comprising:
a safety switch mounted on the grip portion,
wherein the drive portion defines a drive longitudinal axis, and
wherein the center of gravity is located between the safety switch and the finger opening along the drive longitudinal axis.

16. The fastener driver tool as claimed in claim 14, further comprising:
an activation button mounted on the housing and configured to activate the drive mechanism for striking the corresponding fastener,
wherein the drive portion defines a drive longitudinal axis,
wherein the grip portion defines a grip longitudinal axis that is perpendicular to the drive longitudinal axis,
wherein the finger opening defines a finger longitudinal axis that is parallel to the grip longitudinal axis, and
wherein the finger longitudinal axis passes through the activation button.

17. The fastener driver tool as claimed in claim 16, further comprising:
a strap having a first end removably connected to the drive portion of the housing and a second end removably connected to the power supply portion of the housing.

18. The fastener driver tool as claimed in claim 10, further comprising:
a crank mechanism operably connected to the gearbox and the striking mechanism, the crank mechanism configured to compress a spring of the drive mechanism using rotation from the gearbox,
wherein the crank mechanism is located in the housing at an interface of the grip portion and the drive portion.

19. The fastener driver tool as claimed in claim 10, wherein the power supply is a removable battery pack.

20. The fastener driver tool as claimed in claim 10, wherein the power supply is configured for connection to a main power supply.
